(19) United States
(12) Patent Application Publication
(10) Pub. No.: US 2005/0010538 A1
(43) Pub. Date: Jan. 13, 2005

(54) Used article trade-in system and method

(75) Inventors: Yasuhiro Oshima, Nagano-ken (JP); Junji Suzuki, Nagano-ken (JP); Hitoshi Saito, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 10/840,671

(22) Filed: May 7, 2004

(30) Foreign Application Priority Data
May 7, 2003 (JP) 2003-129311

(51) Int. Cl. G06F 17/60

(52) U.S. Cl. 705/80

(57) ABSTRACT

In response to reception of a login request for the trade-in service, a Web server sends a login window to the client computer of a customer via the Internet (step S300). The login window has a trade-in ID input box, a mail address input box, and a ‘Login’ button. After entering a trade-in ID and a mail address into the boxes, the customer clicks the login button. The Web server receives the entries of the trade-in ID and the mail address and determines successful or failed authentication (step S304). In the case of successful authentication, the Web server determines whether preset days have elapsed since the date of purchase order to determine whether the current time is within an allowable trade-in period (step S306). In the case of the current time is within the trade-in period and prior to trade-in reception, the Web server executes a trade-in reception routine (step S314).

### BACKGROUND OF THE INVENTION

1. Field of the Invention

The present invention relates to a used article trade-in system and corresponding method.

2. Description of the Prior Art

In a proposed used article trade-in system that allows a customer to trade in a used article on the condition of purchase of a product, each customer who purchases a product from a seller browses product information registered in a Web server and selects a desired product for purchase. The customer then registers customer information, information on the purchased product, and information on a trade-in product for a trade-in for the purchased product into the Web server (see, for example, Japanese Patent Laid-Open Gazette No. 2003-58728).

In the prior art used article trade-in system, a trade-in procedure for trade-in of a used article is required simultaneously with or at the latest, immediately after a purchase procedure of a product. The customer is not permitted to trade in a used article some time after purchase of a product from the seller. This results in the poor effectiveness of trade-in of the used article. Cancellation of the trade-in of the used article after completion of the trade-in procedure is very complicated and difficult. Flexibility is thus desired for the trade-in procedure for trade-in of the used article.

### SUMMARY OF THE INVENTION

By taking into account the drawbacks of the prior art technique discussed above, the object of the invention is to provide a used article trade-in system, and corresponding method and program that enable effective trade-in of a used article on the condition of a purchase of a product. The object of the invention is further to provide the used article trade-in system, the method, and the program that enhance the flexibility of trade-in of a used article.

In order to achieve at least part of the aforementioned objects, the present invention is constructed as follows.

A used article trade-in system of the present invention is a system that allows a customer to trade in a used article on the condition of purchase of a product, the used article trade-in system including: an identification information notification module that assigns identification information to the customer's purchase order of a product and notifies the customer of the assigned identification information; a storage control module that stores information regarding validity of the identification information in a memory unit; an identification information acquisition module that obtains identification information from a customer who requests a trade-in; a validity determination module that determines whether the identification information obtained by the identification information acquisition module is valid, based on the information regarding the validity of the identification information stored in the memory unit; and a trade-in procedure execution module that asks the customer who requests a trade-in to go through a procedure required for trade-in of a used article, when the validity determination module determines that the identification information is valid.

The used article trade-in system of the invention obtains identification information from a customer who requests a trade-in, determines whether the obtained identification information is valid, based on the information regarding the validity of the identification information stored in the memory unit, and when it is determined that the identification information is valid, asks the customer who requests a trade-in to go through the procedure required for trade-in of a used article. Even some time after purchase of a product, trade-in of a used article is permitted on the condition that the identification information assigned to the customer's purchase order of the product is valid. This arrangement desirably enhances the effectiveness of trade-in of the used article on the condition of purchase of a product. Here the ‘identification information’ may be any distinguishable information, for example, an identification code including one or multiple digits, characters, graphics, and symbols.

In one preferable embodiment of the used article trade-in system of the invention, the validity determination module in the used article trade-in system determines that the identification information is valid, when the identification information obtained by the identification information acquisition module is present in the memory unit. This arrangement permits trade-in of a used article on the condition that the identification information is assigned in the present used article trade-in system.

In another preferable embodiment of the used article trade-in system of the invention, the storage control module stores a date of purchase order corresponding to the identification information as the information regarding the validity of the identification information, and the validity determination module determines that the identification information is valid, when current time is prior to elapse of a preset time period since the date of purchase order corresponding to the identification information obtained by the identification information acquisition module. As one modified structure of this embodiment, the used article trade-in system may further include a setting change module that varies the setting of the preset time period.

In the used article trade-in system of the invention, the product and the used article may be both personal computers.

In another preferable embodiment of the used article trade-in system of the invention, the storage control module stores the identification information in relation to customer-related information in the memory unit, the identification information acquisition module obtains the identification information and the customer-related information from the customer who requests a trade-in, and the validity determination module compares the identification information and the customer-related information obtained by the identification information acquisition module with the storage in the memory unit and determines whether the identification information is valid, based on a result of the comparison. In this embodiment, the validity of the identification information is determined, based on comparison of the identification information and the customer-related information with the storage in the memory unit. This arrangement ensures the accurate authentication of the person who requests a trade-in as the customer who has purchased a product. Here the ‘customer-related information’ may be any information related to the customer, for example, the name, the postal address, the birthday, the telephone number, the fax number, or the mail address of the customer.

In still another preferable embodiment of the used article trade-in system of the invention, the trade-in procedure execution module obtains used article specification information for identifying a used article as a trade-in object from the customer who requests a trade-in when the customer goes through the procedure required for trade-in of the used article, and stores the used article specification information in relation to the identification information into the memory unit. Here the ‘used article specification information’ is, for example, the product name of the used article, the name of the manufacturer of the used article, the serial number or the product number of the used article, or information regarding some parts of the used article (the names and performances of the parts).

As one preferable application of the above embodiment, the trade-in procedure execution module, when the validity determination module determines that the identification information is valid, may determine whether used article specification information in relation to the identification information is stored in the memory unit, and in the case of no storage of the used article specification information in relation to the identification information in the memory unit, cause the customer who requests a trade-in to enter used article specification information and stores the entry of the used article specification information in relation to the identification information into the memory unit. As another preferable application of the above embodiment, the trade-in procedure execution module, when the validity determination module determines that the identification information is valid, may determine whether used article specification information in relation to the identification information is stored in the memory unit, and in the case of storage of the used article specification information in relation to the identification information in the memory unit, present an assignment for assigning a used article identified by the used article specification information to a trade-in agent, to the customer who requests a trade-in. As still another application of the above embodiment, the trade-in procedure execution module, when the validity determination module determines that the identification information is valid, may determine whether used article specification information in relation to the identification information is stored in the memory unit, and in the case of storage of the used article specification information in relation to the identification information in the memory unit, cause the customer who requests a trade-in to select a desired option among multiple options including modification and deletion of the used article specification information and updates the used article specification information based on the customer's selection. Here, the multiple options may include presentation of an assignment for assigning a used article identified by the used article specification information to a trade-in agent, in addition to modification and deletion of the used article specification information. And in this application, the trade-in procedure execution module may store information representing either a completed trade-in process or an incomplete trade-in process as part of the used article specification information in relation to the identification information in the memory unit, and cause the customer who requests a trade-in to select a desired option among the multiple options and updates the used article specification information based on the customer's selection, only in the case of storage of the used article specification information in relation to the identification information in the memory unit and the incomplete trade-in process.

In still another preferable embodiment of the used article trade-in system of the invention, the identification information acquisition module obtains the identification information from a computer of the customer who requests a trade-in via a telecommunication line, and the trade-in procedure execution module causes the customer who requests a trade-in to go through the procedure required for trade-in of a used article via the telecommunication line. Here, the telecommunication line is, for example, the Internet or an intranet (including LAN).

A used article trade-in method of the present invention is a method actualized by computer software to allow a customer to trade in a used article on the condition of purchase of a product, the used article trade-in method including the steps of: (a) assigning identification information to the customer's purchase order of a product and notifying the customer of the assigned identification information; (b) storing information regarding validity of the identification information in a memory unit; (c) obtaining identification information from a customer who requests a trade-in; (d) determining whether the identification information obtained in the step (c) is valid, based on the information regarding the validity of the identification information stored in the memory unit; and (e) asking the customer who requests a trade-in to go through a procedure required for trade-in of a used article, when it is determined that the identification information is valid in the step (d).

The used article trade-in method of the invention permits trade-in of a used article even some time after purchase of a product, on the condition that the identification information assigned to the customer's purchase order of the product is valid. This arrangement desirably enhances the effectiveness of trade-in of the used article on the condition of purchase of a product. The used article trade-in method may have additional steps corresponding to the additional functions of the used article trade-in system described above.

In one preferable embodiment of the used article trade-in method of the invention, the step (e) obtains used article specification information for identifying a used article as a trade-in object from the customer who requests a trade-in when the customer goes through the procedure required for trade-in of the used article, and stores the used article specification information in relation to the identification information into the memory unit.

As one preferable application of this embodiment, the step (e), when it is determined that the identification information is valid in the step (d), may determine whether used article specification information in relation to the identification information is stored in the memory unit, and in the case of no storage of the used article specification information in relation to the identification information in the memory unit, cause the customer who requests a trade-in to enter used article specification information and stores the entry of the used article specification information in relation to the identification information into the memory unit. As another preferable application of this embodiment, the step (e), when it is determined that the identification information is valid in the step (d), may determine whether used article specification information in relation to the identification information is stored in the memory unit, and in the case of storage of the used article specification information in relation to the identification information in the memory unit, present an assignment for assigning a used article identified by the used article specification information to a trade-in agent, to the customer who requests a trade-in. As still another preferable application of the embodiment, the step (e), when it is determined that the identification information is valid in the step (d), may determine whether used article specification information in relation to the identification information is stored in the memory unit, and in the case of storage of the used article specification information in relation to the identification information in the memory unit, cause the customer who requests a trade-in to select a desired option among multiple options including modification and deletion of the used article specification information and updates the used article specification information based on the customer's selection. Here, the multiple options may include presentation of an assignment for assigning a used article identified by the used article specification information to a trade-in agent, in addition to modification and deletion of the used article specification information. And in this application, the step (e) may store information representing either a completed trade-in process or an incomplete trade-in process as part of the used article specification information in relation to the identification information in the memory unit, and cause the customer who requests a trade-in to select a desired option among the multiple options and updates the used article specification information based on the customer's selection, only in the case of storage of the used article specification information in relation to the identification information in the memory unit and the incomplete trade-in process.

The present invention is also applicable to a program that causes one or multiple computers to execute respective steps of the used article trade-in method discussed above. The program may be recorded in a computer readable recording medium (for example, a hard disk, a ROM, an FD, a CD, or a DVD), may be transferred from one computer to another computer via a transfer medium (a communication network like the Internet or a LAN), or may be transmitted in any other suitable form. Causing one computer to exert all the steps or causing multiple computer share the steps of the program attains the equivalent effects to those of the used article trade-in method discussed above.

### BRIEF DESCRIPTION OF THE DRAWINGS

FIG. 1 schematically illustrates the construction of a used article trade-in system 10; FIG. 2 is a flowchart showing an order reception process; FIG. 3 shows an order confirmation window 30; FIG. 4 shows a personal computer trade-in service description window 40; FIG. 5 is a flowchart showing a trade-in reception routine; FIG. 6 is a flowchart showing a trade-in login processing routine; FIG. 7 shows windows displayed in the trade-in login processing routine; FIG. 8 is a flowchart showing a trade-in login processing routine in one modified structure; and FIG. 9 shows windows displayed in the trade-in login processing routine in the modified structure.

### DESCRIPTION OF THE PREFERRED EMBODIMENTS

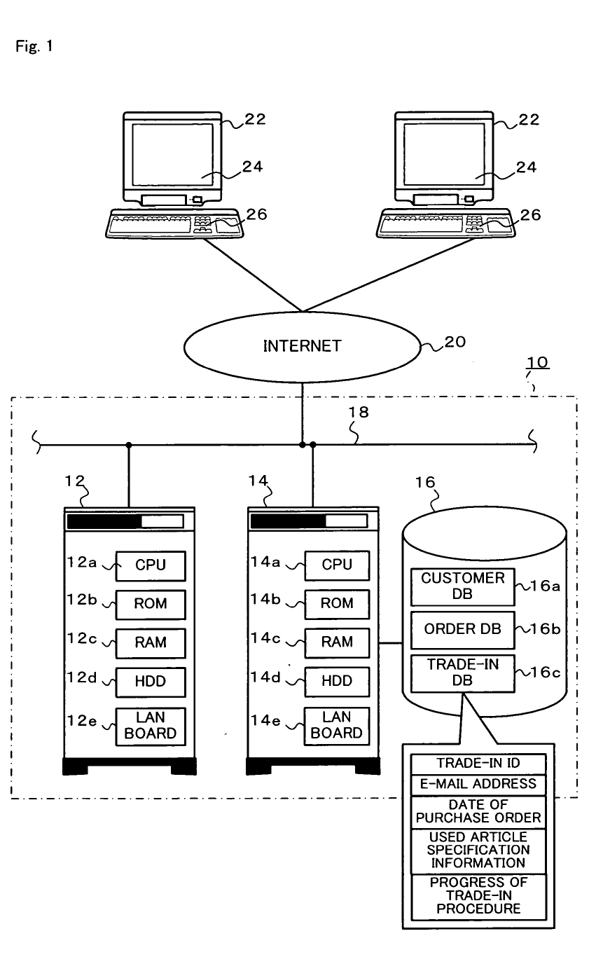

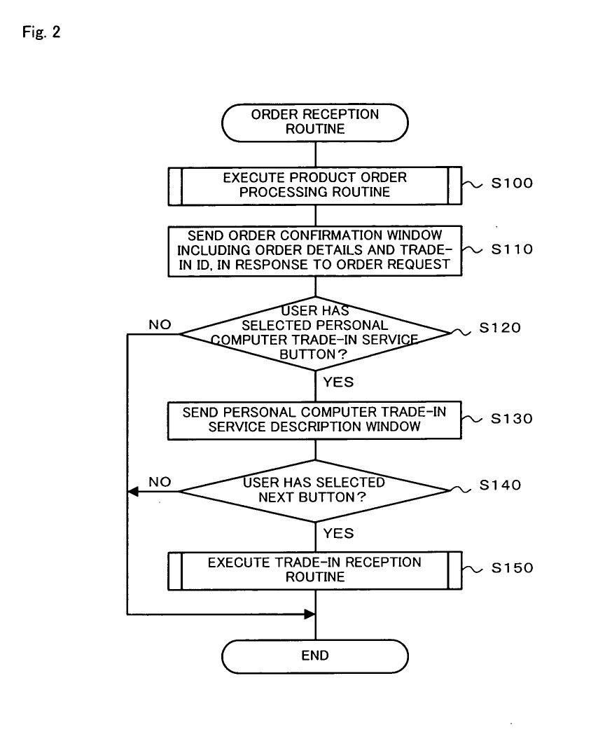

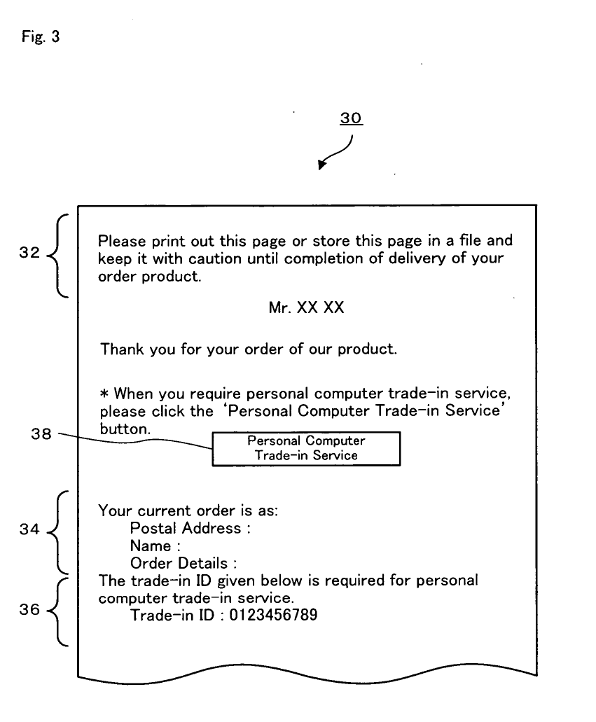

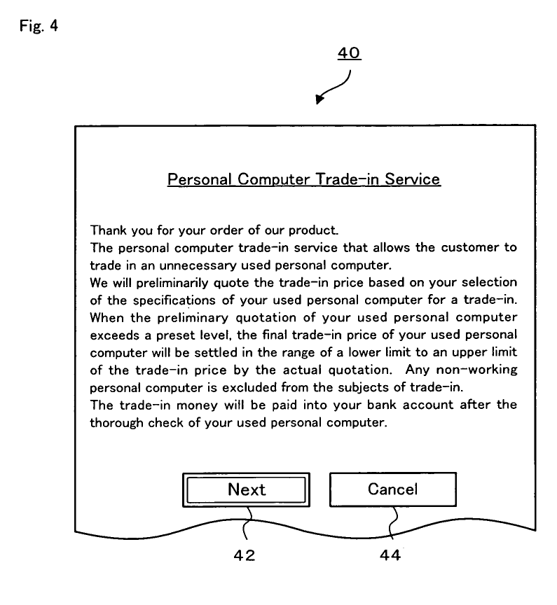

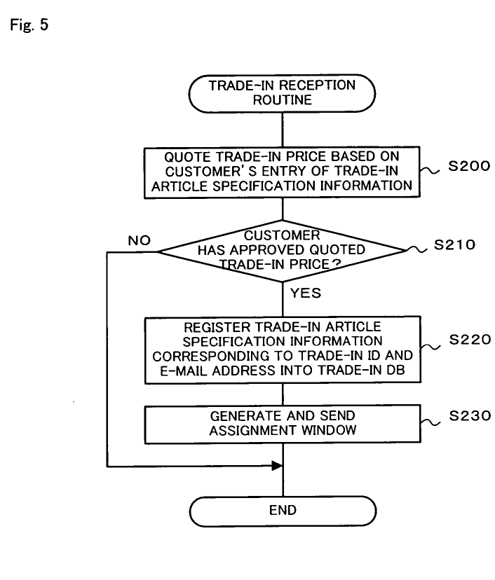

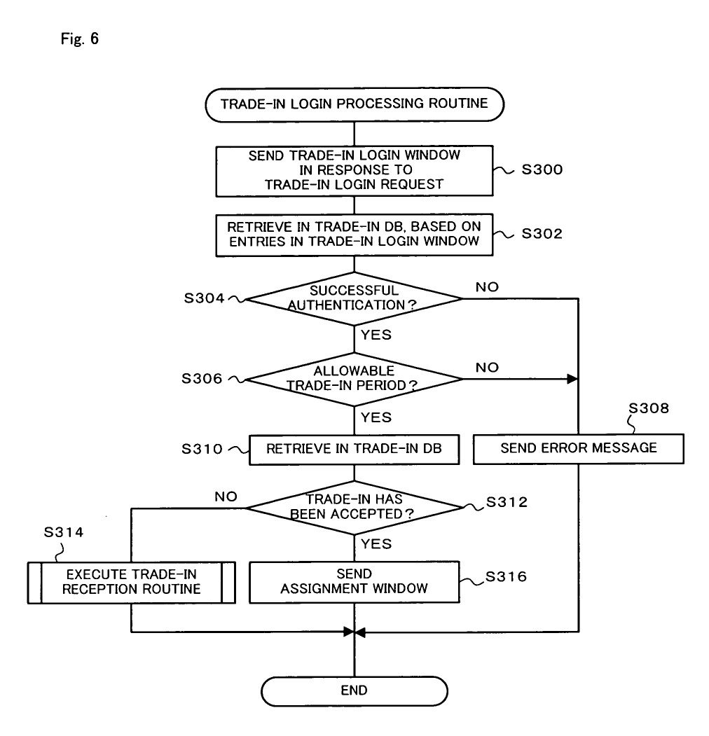

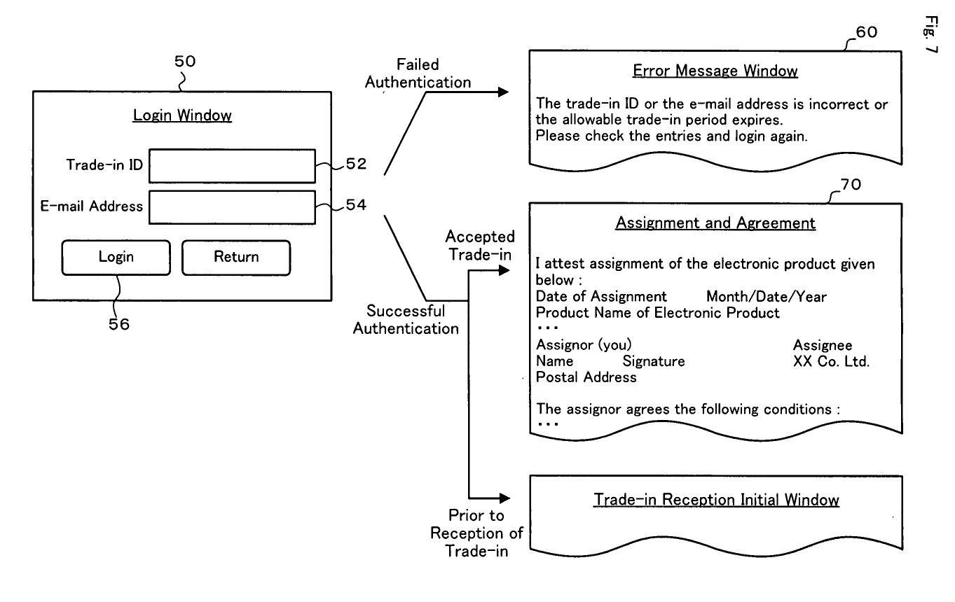

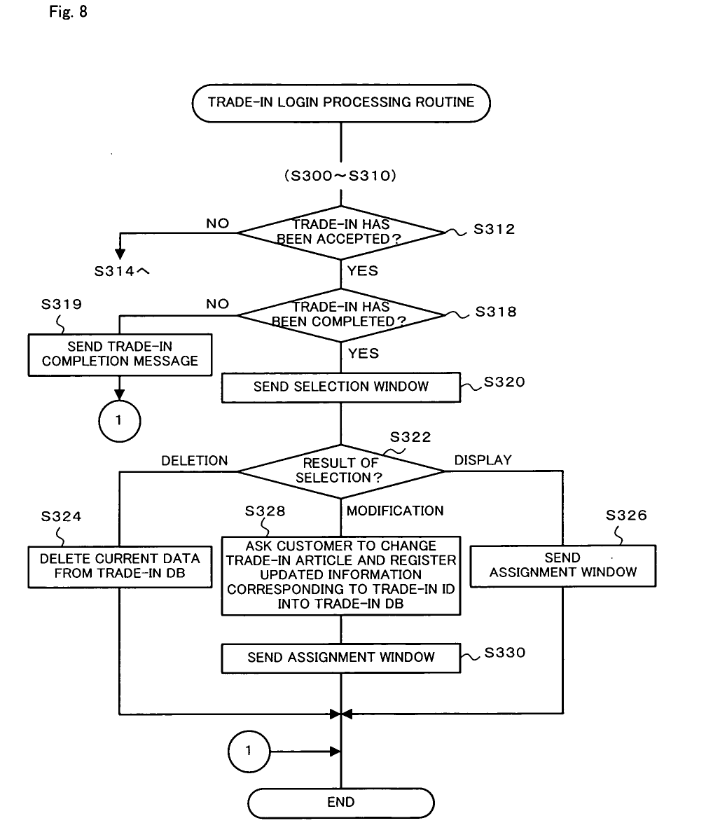

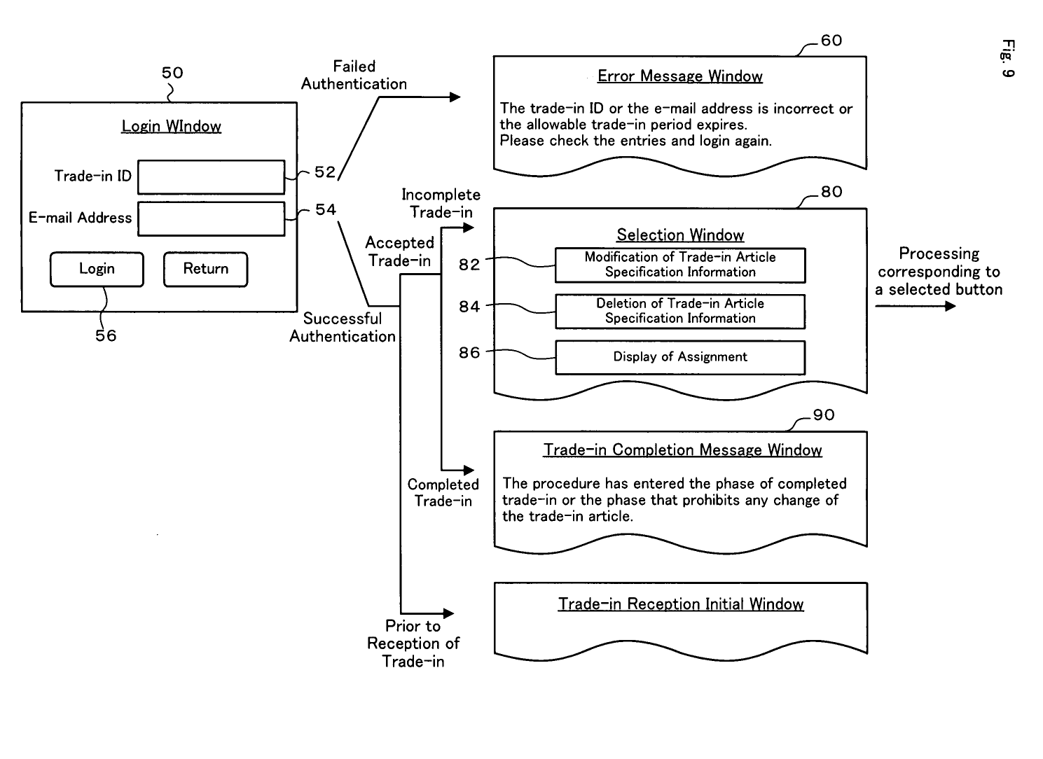

One mode of carrying out the invention is described with reference to the drawings. FIG. 1 schematically illustrates the construction of a used article trade-in system 10 in one embodiment of the invention. The used article trade-in system 10 of the embodiment has a Web server 12 that sets up an online shopping site and a trade-in service site and a database server 14 that stores customer information, order information, and trade-in information as databases into a storage device 16.

The Web server 12 is a known server computer including a CPU 12a that executes various controls, a ROM 12b that stores various control programs, a RAM 12c that temporarily stores data, an HDD 12d that records diverse application programs and various data files, and a LAN board 12e that is connected with a LAN cable 18. The Web server 12 is connected to the Internet 20 as a telecommunication line via a router (not shown), which is linked with the LAN cable 18, and sets up an online shopping site to sell personal computers on the Internet 20 and a trade-in service site to allow the customer to trade in used personal computers. The Web server 12 works as a request front server that receives requests from customers' client computers 22 via the Internet 20, and functions to send a response to each request received from one of the client computers 22 to the corresponding client computer 22 and to send customer information and order information received from any of the client computers 22 to the database server 14 via the LAN cable 18.

Like the Web server 12, the database server 14 is a known server computer including a CPU 14a that executes various controls, a ROM 14b that stores various control programs, a RAM 14c that temporarily stores data, an HDD 14d that records diverse application programs and various data files, and a LAN board 14e that is connected with the LAN cable 18. The database server 14 establishes communication with the Web server 12 via the LAN cable 18 to read information from the storage device 16 and send the information to the Web server 12 and to store information received from the Web server 12 into the storage device 16 according to the requirements. The storage device 16 has a customer DB 16a storing customer information in a database, an order DB 16b storing order information in a database, and a trade-in DB 16c storing trade-in information in a database. Here the customer information represents pieces of information registered by each customer for an order of a product at the online shopping site and includes a customer ID allocated to each customer and the postal address, the name, the age, and the mail address of the customer. The order information represents pieces of information regarding a product ordered by a customer at the online shopping site and includes an order ID allocated to each order, the date of receiving the order, and the product name, the serial number, and the purchase volume of a product involved in the current order. The trade-in information represents pieces of information regarding a used personal computer to be traded in for the customer's purchase of a new product and includes a trade-in ID allocated to each product purchase order, the mail address of the customer who has purchased the product, used personal computer specification information for specifying the used personal computer, and information on the progress of a trade-in procedure. The used personal computer specification information may be the product name and the serial number of the used personal computer or specifications of the used personal computer (for example, the CPU processor name, the clock rate, the RAM capacity, and the HDD capacity).

Each of the client computers 22 is a known general-purpose personal computer and uses a Web browser installed therein to send requests to the Web server 12 and receive responses from the Web server 12 via the Internet 20. The client computer 22 has a display 24 to display various pieces of information on the screen and an input device 26 including a keyboard manipulated by the customer to enter diverse commands and instructions. The client computer 22 functions to display a browser window sent from the Web server 12 on the display 24 and to execute a corresponding operation in response to the customer's ON operation of a button on the browser window through manipulation of the input device 26.

The following describes the operations of the used article trade-in system 10 of the embodiment constructed as discussed above, especially the operations of the Web server 12. FIG. 2 is a flowchart showing an order reception process executed by the CPU 12a of the Web server 12. As a matter of convenience, the flow of the order reception process by the Web server 12 is described with reference to the flowchart. The actual order reception process is, however, communication processing executed by the Web server 12 in combination with the client computer 22. The actual order reception process may thus not follow the flowchart according to the details of a request from the client computer 22.

The Web server 12 establishes communication with the client computer 22 via the Internet 20 and executes a product order processing routine (step S100). The product order processing routine sends a product presentation page of the online shopping site including lineup of recommended personal computers to the client computer 22 of the customer. In response to reception of the customer's selection of a desired personal computer among the lineup to be added to the shopping cart from the client computer 22, the product order processing routine sends a cart window showing the price of the selected personal computer to the client computer 22. In response to reception of the customer's entry of the customer information including the postal address, the name, the telephone number, and the mail address of the customer for purchase of the selected personal computer and information regarding payment and the customer's final confirmation for the purchase from the client computer 22, the product order processing routine causes the database server 14 to register the customer information and the order information currently obtained into the customer DB 16a and the order DB 16b, allocates a trade-in ID to the current order, and causes the database server 14 to register the allocated trade-in ID, the mail address of the customer, and the date of purchase order into the trade-in DB 16c.

The Web server 12 then sends an order confirmation window 30 shown in FIG. 3 to the client computer 22 (step S110). The order confirmation window 30 includes an instruction display field 32 to display a cautionary statement of storing this page with caution, an order details display field 34 to display the details of the current order, a trade-in ID display field 36 to display the trade-in ID allocated to the current order and a message showing that the trade-in ID is required for personal computer trade-in service, and a ‘Personal Computer Trade-in Service’ button 38 that is selected when the customer has any used personal computer for a trade-in. The Web server 12 determines whether the customer has selected the ‘Personal Computer Trade-in Service’ button 38 through manipulation of the input device 26 or has concluded the processing without selection of this button 38, based on the information sent from the client computer 22 (step S120). When the customer selects the ‘Personal Computer Trade-in Service’ button 38, the Web server 12 sends a personal computer trade-in service description window 40 (see FIG. 4) to the client computer 22 (step S130). The description window 40 shows statements of concretely describing the personal computer trade-in service. The Web server 12 subsequently determines whether the customer has selected a ‘Next’ button 42 to enter the personal computer trade-in service or has selected a ‘Cancel’ button 44 to cancel the personal computer trade-in service, based on the information sent from the client computer 22 (step S140). In response to the customer's selection of the ‘Next’ button 42, the Web server 12 executes a trade-in reception routine (step S150) and exits from this order reception process. When the customer has concluded the processing without selection of the ‘Personal Computer Trade-in’ button 38 at step S120 or when the customer has selected the ‘Cancel’ button 44 at step S140, on the other hand, the order reception process is terminated immediately.

The trade-in reception routine is described with reference to the flowchart of FIG. 5. The CPU 12a of the Web server 12 establishes communication with the client computer 22 and asks the user to enter information for identifying a used personal computer as a trade-in object (hereafter referred to as trade-in article specification information). The Web server 12 receives the trade-in article specification information entered by the customer from the client computer 22, quotes a trade-in price based on the received trade-in article specification information, and sends the trade-in price to the client computer 22 (step S200). The Web server 12 then determines whether the customer has approved the trade-in of the trade-in object at the quoted trade-in price or has cancelled the trade-in, based on the information sent from the client computer 22 (step S210). The Web server 12 terminates this trade-in reception routine, in response to the customer's cancellation of the trade-in. When the customer has approved the trade-in, on the other hand, the Web server 12 sends the trade-in article specification information currently obtained to the database server 14 and causes the database server 14 to register the trade-in article specification information corresponding to the trade-in ID and the mail address of the customer into the trade-in DB 16c (step S220). The Web server 12 then creates an assignment window 70 (see FIG. 7) for assignment of the used personal computer to a trade-in agent and sends the assignment window 70 to the client computer 22 (step S230). The trade-in reception routine is here terminated. The customer checks the assignment window 70 on the display 24 of the client computer 22, prints an assignment, signs and seals the printed assignment, and hands over the signed and sealed assignment with the used personal computer.

The trade-in article specification information may be, for example, the product name, the manufacturer, and the serial number of the used personal computer, which are entered by the customer and are obtained from the client computer 22 via the Internet 20. The trade-in article specification information may otherwise be the specifications of the used personal computer (for example, the CPU processor name, the clock rate, the RAM capacity, and the HDD capacity), which are entered by the customer and are obtained from the client computer 22 via the Internet 20. In this embodiment, the trade-in price is quoted with reference to a price DB (not shown) based on the trade-in article specification information and is given as a price range of a lower limit to an upper limit. The quoted trade-in price is given as the price range, since the used personal computers of an identical model may not have an identical trade-in value according to their appearances and working conditions. The final trade-in price is settled in this price range by the actual quotation of the used personal computer.

The customer may request a trade-in of a used personal computer some time after the purchase order of a product at the online shopping site set up by the Web server 12. This case is explained with reference to FIGS. 6 and 7. FIG. 6 is a flowchart showing a trade-in login processing routine executed by the CPU 12a of the Web server 12. FIG. 7 shows windows displayed in the trade-in login processing routine. As a matter of convenience, the flow of the trade-in login processing by the Web server 12 is described with reference to the flowchart. The actual trade-in login processing is, however, communication processing executed by the Web server 12 in combination with the client computer 22. The actual trade-in login processing may thus not follow the flowchart according to the details of a request from the client computer 22.

In response to reception of a login request for the trade-in service from the client computer 22, the Web server 12 sends a login window 50 for the trade-in service (see FIG. 7) to the client computer 22 via the Internet 20 (step S300). The customer clicks a login button provided on a preset page at the trade-in service site to effectuate the login request for the trade-in service. The customer enters this preset page by, for example, clicking a URL included in an e-mail sent to the customer after the purchase order at the online shopping site. The client computer 22 receives the login window 50 and opens the login window 50 on the display 24. The login window 50 has a trade-in ID input box 52 to enter the trade-in ID, a mail address input box 54 to enter the mail address, and a ‘Login’ button 56 for the login request. The customer reads the trade-in ID shown in the trade-in ID display field 36 on the order confirmation window 30 (see FIG. 3) and enters the trade-in ID into the trade-in ID input box 52. The customer also enters the mail address, which has been input as a piece of the customer information at the time of purchase of a product, into the mail address input box 54 and clicks the ‘Login’ button 56. The client computer 22 then sends the entries of the trade-in ID and the mail address to the Web server 12 via the Internet 20.

The Web server 12 receives the entries of the trade-in ID and the mail address and causes the database server 14 to retrieve in the trade-in DB 16c and find whether the trade-in ID and the mail address are present in the trade-in DB 16c (step S302), and determines successful or failed authentication based on the result of the retrieval (step S304). In the case of successful authentication, that is, when the trade-in ID and the mail address are present in the trade-in DB 16c, the Web server 12 causes the database server 14 to read the date of purchase order from the trade-in DB 16c and determines whether preset days (for example, 30 days) have elapsed since the date of purchase order to determine whether the current time is within an allowable trade-in period (step S306). When the current time is within the allowable trade-in period, the Web server 12 causes the database server 14 to retrieve the trade-in article specification information registered corresponding to the trade-in ID and the mail address in the trade-in DB 16c (step S310). The Web server 12 determines whether the trade-in has already been accepted (accepted trade-in) or has not yet been accepted (prior to trade-in reception), based on the result of the retrieval (step S312). In the case of prior to trade-in reception, that is, when the corresponding trade-in article specification information has not been registered in the trade-in DB 16c, the Web server 12 determines that the customer newly requests a trade-in and executes the trade-in reception routine discussed above (step S314). The trade-in login processing routine is then terminated.

In the case of accepted trade-in at step S312, that is, when the corresponding trade-in article specification information has been registered in the trade-in DB 16c, on the other hand, the Web server 12 sends the assignment window 70, which is created and sent at step S230 in the trade-in reception routine, to the client computer 22 (step S316) and exits from this trade-in login processing routine. FIG. 7 shows the assignment window 70 as an example of the display in the case of the successful authentication and accepted trade-in. In the case of failed authentication at step S304, that is, when the trade-in ID and the mail address are not present in the trade-in DB 16c, or when the current time is not within the allowable trade-in period at step S306, the Web server 12 sends an error message to the client computer 22 (step S308) and exits from this trade-in login processing routine. FIG. 7 shows an error message window 60 as an example of the display in the case of failed authentication.

The CPU 12a and the LAN board 12e of the Web server 12 in this embodiment correspond to the identification information notification module, the identification information acquisition module, and the trade-in procedure execution module of the invention. The CPU 12a of the embodiment corresponds to the storage control module and the validity determination module of the invention. The storage device 16 corresponds to the memory unit, and the trade-in ID corresponds to the identification information. Description of the operations of the used article trade-in system in the embodiment clarifies an example of the used article trade-in method of the invention.

As described above, the used-article trade-in system 10 of the embodiment receives the trade-in ID from each customer who requests a trade-in. When the trade-in ID is present in the trade-in DB 16c of the storage device 16 and when it is determined that the current time is before elapse of preset days since the date of purchase order, the used article trade-in system 10 determines that the trade-in ID is valid and allows the customer to go through the procedure required for a trade-in of a used article. Even some time after purchase of a product, a trade-in of a used article is allowed only on the condition that the trade-in ID allocated at the time of purchase order is valid. This arrangement desirably enhances the effectiveness of a trade-in of a used article on the condition of purchase of a product.

In the above embodiment, the product sold at the online shopping site and the used article collected at the trade-in service site are both personal computers. There is generally a time difference between the time of purchase of a new product and the time of a trade-in of a used article, since it is required to transfer data stored in the used personal computer into a newly purchased personal computer. The arrangement of the invention is thus effective for these personal computers.

The validity of the trade-in ID is determined, based on not only the trade-in ID but the mail address as one of the customer information. This arrangement ensures the accurate authentication of the person who requests a trade-in as the customer who has purchased a product.

When it is determined that the trade-in ID is valid but the trade-in article specification information corresponding to the trade-in ID is not present in the trade-in DB 16c, the trade-in reception routine is executed to ask the customer to enter the trade-in article specification information. This arrangement ensures appropriate processing for the customer who newly requests a trade-in. When it is determined that the trade-in ID is valid and the trade-in article specification information corresponding to the trade-in ID is present in the trade-in DB 16c, on the other hand, the assignment window is presented to the customer. The customer who has already requested a trade-in of a used personal computer can thus check and print an assignment required to be attached for a trade-in of the used personal computer any time.

The above embodiment is to be considered in all aspects as illustrative and not restrictive. There may be many modifications, changes, and alterations without departing from the scope or spirit of the main characteristics of the present invention. All changes within the meaning and range of equivalency of the claims are therefore intended to be embraced therein.

The trade-in login processing routine of FIG. 6 executed in the embodiment may be replaced by another trade-in login processing routine shown in the flowchart of FIG. 8. The processing routine of FIG. 8 has steps S300 through S314, which are identical with those of the processing routine of FIG. 6. The primary difference is execution of step S320 and subsequent steps in the case of accepted trade-in at step S312 as described below. After reception of a trade-in, the CPU 12a of the Web server 12 registers the information on the progress of the trade-in procedure of a used personal computer corresponding to the trade-in ID into the trade-in DB 16c. In the case of accepted trade-in at step S312, the Web server 12 determines whether a trade-in has already been completed or has not yet been completed (step S318). In the case of the completed trade-in (when the procedure has entered the phase of picking up the customer's used personal computer), the Web server 12 sends a trade-in completion message, which shows completion of a trade-in or the progress of the trade-in procedure to the stage of prohibition of any modification of the trade-in article specification information, to the client computer 22 (step S319) and exits from this trade-in login processing routine. FIG. 9 shows a trade-in completion message window 90 as an example of the display in the case of successful authentication, accepted trade-in, and completed trade-in. In the case of incomplete trade-in, the Web server 12 sends a selection window 80 (see FIG. 9) to the client computer 22 (step S320). FIG. 9 shows the selection window 80 as an example of the display in the case of successful authentication, accepted trade-in, and incomplete trade-in. The selection window 80 has a change button 82 selected to modify the trade-in article specification information, a delete button 84 selected to delete the trade-in article specification information, and an assignment display button 86 selected to display an assignment of the used personal computer. The client computer 22 then opens the selection window 80 on the display 24. The customer is asked to select a desired button among the three buttons 82, 84, and 86 by manipulating the input device 26. The client computer 22 then sends a request corresponding to the selected button on the selection window 80 to the Web server 12 via the Internet 20. The Web server 12 specifies the result of the customer's selection, based on the request sent from the client computer 22 (step S322). When the customer selects deletion of the trade-in article specification information, the Web server 12 causes the database server 14 to delete the current trade-in article specification information from the trade-in DB 16c of the storage device 16 (step S324) and exits from this trade-in login processing routine. When the customer selects display of an assignment, the Web server 12 sends the assignment window 70 (see FIG. 7), which is created and sent at step S230 in the trade-in reception routine, to the client computer 22 (step S326) and exits from this trade-in login processing routine. When the customer selects modification of the trade-in article specification information, the Web server 12 sends a trade-in article specification information change window (not shown) to the client computer 22, receives the modified settings entered by the customer, and causes the database server 14 to register the updated trade-in article specification information corresponding to the trade-in ID into the trade-in DB 16c (step S328). The Web server 12 then creates the assignment window 70 (see FIG. 7) for assignment of the used personal computer to a trade-in agent and sends the assignment window 70 to the client computer 22 (step S330). The trade-in login processing routine is here terminated. The customer who has requested a trade-in of a used personal article may change the used personal computer for the trade-in or cancel the trade-in. This arrangement desirably enhances the flexibility of trade-in of the used article. Update or deletion of the trade-in article specification information is prohibited after completion of a trade-in. This arrangement effectively prevents the potential troubles by such update or deletion after completion of a trade-in.

The procedure of the embodiment displays the assignment window 70 (see FIG. 7) in the case of successful authentication and accepted trade-in. The display of the assignment window 70 may be replaced by display of the trade-in article specification information to ask the customer to check the trade-in article currently received. The authentication display button 86 on the selection window 80 shown in FIG. 9 may be omitted, when not required.

In the embodiment and its modified example discussed above, the trade-in ID is determined as valid on the condition that the current time is prior to elapse of preset days since the date of product purchase order. The system administrator may vary the setting of the preset days in the Web server 12 according to the requirements. This gives the flexibility to trade-in of used articles. For example, the preset days may be a longer period in a special term like a campaign term.

In the embodiment and its modified example discussed above, the product purchased at the online shopping site and the used article traded in are both personal computers. The purchased product and the trade-in used article may be an identical type or different type of products and may be or may not be personal computers.

In the embodiment and its modified example discussed above, the trade-in ID is allocated to each product purchase order. The trade-in ID may alternatively be allocated to each product in a purchase order. The order ID, instead of the trade-in ID, may be entered in the login window 50 of FIG. 5.

1. A used article trade-in system that allows a customer to trade in a used article on the condition of purchase of a product, said used article trade-in system comprising:
an identification information notification module that assigns identification information to the customer's purchase order of a product and notifies the customer of the assigned identification information;
a storage control module that stores information regarding validity of the identification information in a memory unit;
an identification information acquisition module that obtains identification information from a customer who requests a trade-in;
a validity determination module that determines whether the identification information obtained by said identification information acquisition module is valid, based on the information regarding the validity of the identification information stored in said memory unit; and
a trade-in procedure execution module that asks the customer who requests a trade-in to go through a procedure required for trade-in of a used article, when said validity determination module determines that the identification information is valid.

2. A used article trade-in system in accordance with claim 1, wherein said validity determination module determines that the identification information is valid, when the identification information obtained by said identification information acquisition module is present in said memory unit.

3. A used article trade-in system in accordance with claim 1, wherein said storage control module stores a date of purchase order corresponding to the identification information as the information regarding the validity of the identification information, and
said validity determination module determines that the identification information is valid, when current time is prior to elapse of a preset time period since the date of purchase order corresponding to the identification information obtained by said identification information acquisition module.

4. A used article trade-in system in accordance with claim 3, said used article trade-in system further comprising:
a setting change module that varies the setting of the preset time period.

5. A used article trade-in system in accordance with claim 1, wherein the product and the used article are both personal computers.

6. A used article trade-in system in accordance with claim 1, wherein said storage control module stores the identification information in relation to customer-related information in said memory unit,
said identification information acquisition module obtains the identification information and the customer-related information from the customer who requests a trade-in, and
said validity determination module compares the identification information and the customer-related information obtained by said identification information acquisition module with the storage in said memory unit and determines whether the identification information is valid, based on a result of the comparison.

7. A used article trade-in system in accordance with claim 1, wherein said trade-in procedure execution module obtains used article specification information for identifying a used article as a trade-in object from the customer who requests a trade-in when the customer goes through the procedure required for trade-in of the used article, and stores the used article specification information in relation to the identification information into said memory unit.

8. A used article trade-in system in accordance with claim 7, wherein said trade-in procedure execution module, when said validity determination module determines that the identification information is valid, determines whether used article specification information in relation to the identification information is stored in said memory unit, and in the case of no storage of the used article specification information in relation to the identification information in said memory unit, causes the customer who requests a trade-in to enter used article specification information and stores the entry of the used article specification information in relation to the identification information into said memory unit.

9. A used article trade-in system in accordance with claim 7, wherein said trade-in procedure execution module, when said validity determination module determines that the identification information is valid, determines whether used article specification information in relation to the identification information is stored in said memory unit, and in the case of storage of the used article specification information in relation to the identification information in said memory unit, presents an assignment for assigning a used article identified by the used article specification information to a trade-in agent, to the customer who requests a trade-in.

10. A used article trade-in system in accordance with claim 7, wherein said trade-in procedure execution module, when said validity determination module determines that the identification information is valid, determines whether used article specification information in relation to the identification information is stored in said memory unit, and in the case of storage of the used article specification information in relation to the identification information in said memory unit, causes the customer who requests a trade-in to select a desired option among multiple options including modification and deletion of the used article specification information and updates the used article specification information based on the customer's selection.

11. A used article trade-in system in accordance with claim 10, wherein the multiple options include presentation of an assignment for assigning a used article identified by the used article specification information to a trade-in agent, in addition to modification and deletion of the used article specification information.

12. A used article trade-in system in accordance with claim 10, wherein said trade-in procedure execution module stores information representing either a completed trade-in process or an incomplete trade-in process as part of the used article specification information in relation to the identification information in said memory unit, and only in the case of storage of the used article specification information in relation to the identification information in said memory unit and the incomplete trade-in process, causes the customer who requests a trade-in to select a desired option among the multiple options and updates the used article specification information based on the customer's selection.

13. A used article trade-in system in accordance with claim 1, wherein said identification information acquisition module obtains the identification information from a computer of the customer who requests a trade-in via a telecommunication line, and
said trade-in procedure execution module causes the customer who requests a trade-in to go through the procedure required for trade-in of a used article via the telecommunication line.

14. A used article trade-in method actualized by computer software to allow a customer to trade in a used article on the condition of purchase of a product, said used article trade-in method comprising the steps of:
(a) assigning identification information to the customer's purchase order of a product and notifying the customer of the assigned identification information;
(b) storing information regarding validity of the identification information in a memory unit;
(c) obtaining identification information from a customer who requests a trade-in;
(d) determining whether the identification information obtained in said step (c) is valid, based on the information regarding the validity of the identification information stored in said memory unit; and
(e) asking the customer who requests a trade-in to go through a procedure required for trade-in of a used article, when it is determined that the identification information is valid in said step (d).

15. A used article trade-in method in accordance with claim 14, wherein said step (e) obtains used article specification information for identifying a used article as a trade-in object from the customer who requests a trade-in when the customer goes through the procedure required for trade-in of the used article, and stores the used article specification information in relation to the identification information into said memory unit.

16. A used article trade-in method in accordance with claim 15, wherein said step (e), when it is determined that the identification information is valid in said step (d), determines whether used article specification information in relation to the identification information is stored in said memory unit, and in the case of no storage of the used article specification information in relation to the identification information in said memory unit, causes the customer who requests a trade-in to enter used article specification information and stores the entry of the used article specification information in relation to the identification information into said memory unit.

17. A used article trade-in method in accordance with claim 15, wherein said step (e), when it is determined that the identification information is valid in said step (d), determines whether used article specification information in relation to the identification information is stored in said memory unit, and in the case of storage of the used article specification information in relation to the identification information in said memory unit, presents an assignment for assigning a used article identified by the used article specification information to a trade-in agent, to the customer who requests a trade-in.

18. A used article trade-in method in accordance with claim 15, wherein said step (e), when it is determined that the identification information is valid in said step (d), determines whether used article specification information in relation to the identification information is stored in said memory unit, and in the case of storage of the used article specification information in relation to the identification information in said memory unit, causes the customer who requests a trade-in to select a desired option among multiple options including modification and deletion of the used article specification information and updates the used article specification information based on the customer's selection.

19. A used article trade-in method in accordance with claim 18, wherein the multiple options include presentation of an assignment for assigning a used article identified by the used article specification information to a trade-in agent, in addition to modification and deletion of the used article specification information.

20. A used article trade-in method in accordance with claim 18, wherein said step (e) stores information representing either a completed trade-in process or an incomplete trade-in process as part of the used article specification information in relation to the identification information in said memory unit, and only in the case of storage of the used article specification information in relation to the identification information in said memory unit and the incomplete trade-in process, causes the customer who requests a trade-in to select a desired option among the multiple options and updates the used article specification information based on the customer's selection.
